(19) United States
(12) Patent Application Publication
(10) Pub. No.: US 2026/0153228 A1
(43) Pub. Date: Jun. 4, 2026

(54) STEERING WHEEL

(71) Applicant: TOYODA GOSEI CO., LTD., Kiyosu-shi (JP)

(72) Inventors: Kazuma MURAMATSU, Kiyosu-shi (JP); Akitoshi NAGANAWA, Kiyosu-shi (JP)

(21) Appl. No.: 19/389,390

(22) Filed: Nov. 14, 2025

(30) Foreign Application Priority Data
Nov. 29, 2024 (JP) 2024-208110

(51) Int. Cl. F21V 19/00; F21Y 103/37; F21Y 113/00; F21Y 115/10

(52) U.S. Cl. CPC F21V 19/003; F21Y 2103/37; F21Y 2113/00; F21Y 2115/10

(57) ABSTRACT

A steering wheel comprises a substrate having a surface provided with a light-emitting element and a core metal forming a skeleton of the steering wheel. The substrate is arranged in contact with the core metal. A steering wheel comprises the substrate, the core metal and a sheet-like intermediary part interposed between the substrate and the core metal. The intermediary part is configured as a part of a member used as a base material of the steering wheel.

### CROSS REFERENCE TO RELATED APPLICATIONS

The present application claims priority from Japanese patent application No.2024-208110 filed on Nov. 29, 2024, the disclosure of which is hereby incorporated in its entirety by reference into the present application.

### BACKGROUND

### FIELD

The present disclosure relates to a steering wheel.

### RELATED ART

Suggestion has been made to use a device that is attached to a position on a steering wheel visibly recognizable from a driver and emits light such as visible light or infrared light (this device will be called as an “illumination device”). In some cases, such an illumination device uses a substrate provided with a light-emitting element such as an LED. In a steering wheel disclosed in Japanese Patent Application Publication No. 2021-113040, a substrate is arranged in indirect contact with a core metal via a heat transfer member for dissipating heat and a metallic case. With this configuration, heat from the substrate is dissipated by being transferred to the core metal via the heat transfer member and the case.

In the above steering wheel, however, the heat transfer member is provided as a member dedicated to heat dissipation from the substrate. This causes a problem that cost of manufacturing the steering wheel and the size of the steering wheel are increased as a result of the additional member and additional assembling work. This induces a desire for a technique that realizes heat dissipation from the substrate while suppressing increase in the cost of manufacturing the steering wheel and increase in the size of the steering wheel.

### SUMMARY

The present disclosure has been made to solve at least part of the above-described problem, and is feasible in the following aspect.

According to one aspect of the present disclosure, a steering wheel is provided. The steering wheel comprises: a substrate having a surface provided with a light-emitting element; and a core metal forming a skeleton of the steering wheel. The substrate is arranged in contact with the core metal.

### BRIEF DESCRIPTION OF THE DRAWINGS

FIG. 1 is a plan view showing an appearance shape of a steering wheel according to one embodiment of the present disclosure;

FIG. 2 is a plan view showing the appearance shape of the steering wheel from which a lens member and a base member are detached;

FIG. 3 is a first exploded perspective view showing a detailed configuration of an illumination device;

FIG. 4 is a second exploded perspective view showing the detailed configuration of the illumination device;

FIG. 5 is a sectional view showing a section of the steering wheel; and

FIG. 6 is a sectional view showing a section of a steering wheel according to a second embodiment.

### DETAILED DESCRIPTION

### A. First Embodiment

### A1. Overall Configuration of Steering Wheel 100

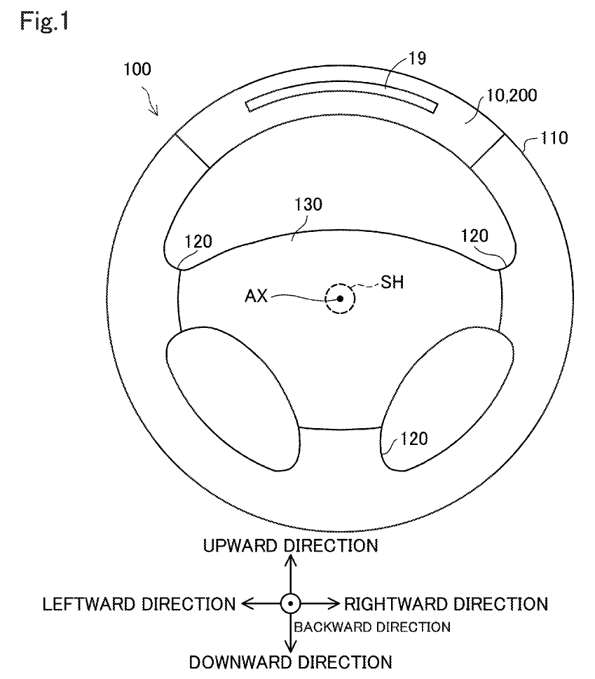

FIG. 1 is a plan view showing an appearance shape of a steering wheel 100 according to one embedment of the present disclosure. The steering wheel 100 is arranged at a driver seat of a vehicle when used. Examples of the vehicle include a vehicle with an engine, a hybrid vehicle (HEV), a plug-in hybrid vehicle (PHEV), a battery electric vehicle (BEV), and a fuel cell vehicle (FCV). The steering wheel 100 is a part of steering devices to be operated by a driver of the vehicle. The steering wheel 100 shown in FIG. 1 is in a state where the steering wheel 100 is coupled to a steering shaft SH in the vehicle and the vehicle is to move straight ahead (this state will also be called a “standard state”). FIG. 1 shows an appearance configuration of the steering wheel 100 on a side facing the driver (“backward direction” side described later). The steering wheel 100 is configured to be capable of being rotated about an axis AX of the steering shaft SH. The rotation of the steering wheel 100 is transmitted via the steering shaft SH to a steering gear box not shown in the drawings.

In the present embodiment, a direction along the axis AX of the steering shaft SH is called a “forward-backward direction” (including a forward direction and a backward direction) in association with a traveling direction of the vehicle. Of directions perpendicular to the axis AX, a direction overlapping a vertical direction (including a vertically-upward direction and a vertically-downward direction) viewed from a driver is called an “upward-downward direction.” Of the directions perpendicular to the axis AX, a direction parallel to a sidewise direction (width direction) of the vehicle is called a “rightward-leftward direction.”

The steering wheel 100 includes a ring-shaped gripping part 110, a boss part 130 arranged in a substantially central area of the gripping part 110, three spoke parts 120, and an illumination device 200 arranged at a part of the gripping part 110.

The gripping part 110 is gripped by a driver during operation of the steering wheel 100. In the present embodiment, the gripping part 110 has a substantially annular shape. The gripping part 110 has a center axis conforming to the axis AX of the steering shaft SH. Instead of the substantially annular shape, the shape of the gripping part 110 may be an arbitrary shape such as a polygonal shape or an oval shape, or may be an asymmetric shape such as a so-called D-shape. The shape of the gripping part 110 is not limited to an annular shape but may be an arbitrary shape composed of a plurality of parts provided at positions apart from each other. As will be described later, the gripping part 110 is configured by stacking a plurality of members in a thickness direction. An outermost layer is composed of an outer coat layer (outer coat layer 80 described later) made of a leather member. While not shown in FIG. 1, a recess part (recess part C1 described later) housing a part of the illumination device 200 is formed in a partial area of the gripping part 110, which is a part of the gripping part 110 on an upward direction side in the standard state. A part of the illumination device 200 is housed in the recess part C1. In other words, the illumination device 200 is fitted in the recess part C1. An opening of the recess part C1 is closed by the illumination device 200.

The three spoke parts 120 couple the gripping part 110 and the boss part 130 to each other. The boss part 130 corresponds to a connection where the steering wheel 100 is connected to the steering shaft SH. The boss part 130 houses therein a folded airbag and an inflator both not shown in the drawings. The boss part 130 may further house therein a temperature adjusting circuit forming a heater unit or various types of sensor units for detecting a room temperature or gripping of the gripping part 110 by a user. The three spoke parts 120 and the boss part 130 may be provided with various types of operation buttons for operating a navigation system, an audio system, etc. mounted on the vehicle, for example.

The illumination device 200 emits light. In the present embodiment, light emitted by the illumination device 200 includes visible light and infrared light (infrared ray). Emitting visible light from the illumination device 200 allows a driver to be notified of various types of information. As an example, emitting rays of light of respective colors or emitting flashing light allows the driver to be notified of certain information. More specifically, emitting red light allows the driver to be urged to grip the steering wheel 100. Furthermore, emitting infrared light from the illumination device 200 allows an infrared camera to capture an image of a part of the body of the driver clearly in a dark vehicle interior at night.

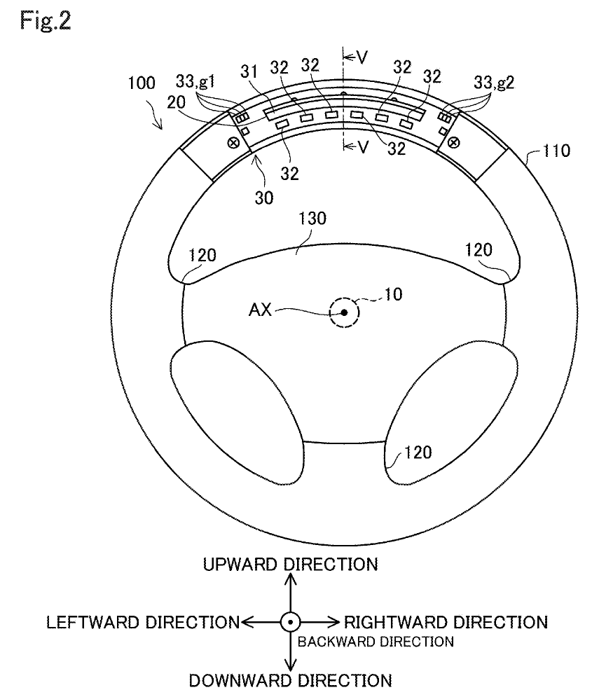

FIG. 2 is a plan view showing the appearance shape of the steering wheel 100 from which a lens member 10 and a base member 40 are detached. As will be described later, at the illumination device 200, the lens member 10 having light transmittance is arranged at a position facing a driver, and a light guide member 20, a light-emitting part 30, and the base member 40 described later are arranged on the forward direction side with respect to the lens member 10. FIG. 2 schematically shows the steering wheel 100 in a state where the lens member 10 and the base member 40 are detached.

As shown in FIG. 2, detaching the lens member 10 and the base member 40 exposes the light-emitting part 30 and the light guide member 20 that are elements forming the illumination device 200. The light-emitting part 30 includes a substrate 31 and a plurality of light-emitting elements provided on a surface of the substrate 31. In the present embodiment, the “plurality of light-emitting elements” includes a plurality of first LEDs 32 provided on the surface of the substrate 31 (surface on the backward direction side), and a plurality of second LEDs 33 provided on the surface of the substrate 31 (surface on the backward direction side). As viewed from a driver, the substrate 31 has an arc-like and stripe-shaped appearance shape curved in a peripheral direction of the gripping part 110 (hereinafter also called a “peripheral direction” simply). In the following, a radial direction of the gripping part 110 (a direction perpendicular to the axis AX) will also be called a “radial direction” simply. The first LEDs 32 are arranged at positions on the surface of the substrate 31 (surface on the backward direction side) and close to an end portion of the surface on the downward direction side while positioned apart from each other at certain distances therebetween in the peripheral direction. The first LEDs 32 emit visible light. In the present embodiment, visible light LEDs capable of emitting red light, green light, and blue light are used as the first LEDs 32. The second LEDs 33 form two groups g1 and g2 positioned apart from each other. Each of the groups g1 and g2 is composed of a plurality of the second LEDs 33 adjacent to each other in the peripheral direction. The two groups g1 and g2 are both arranged at positions on the surface of the substrate 31 (surface on the backward direction side) and close to an end portion of the surface on the upward direction side. As viewed in the peripheral direction, the two groups g1 and g2 are positioned apart from each other across the plurality of first LEDs 32.

The light guide member 20 guides light emitted from the first LED 32 (visible light) to the lens member 10. A detailed configuration of the light guide member 20 will be described later.

### A2. Detailed Configuration of Illumination Device 200

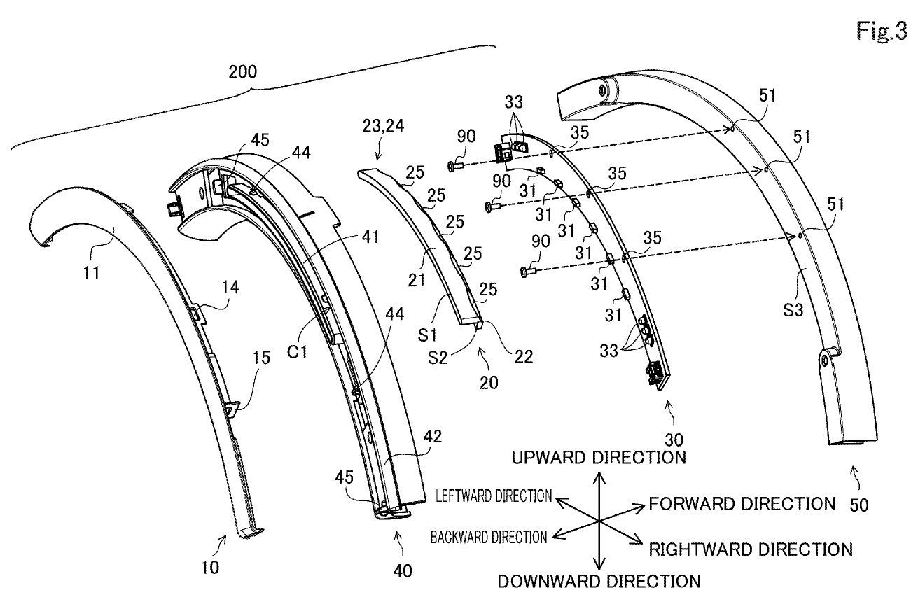

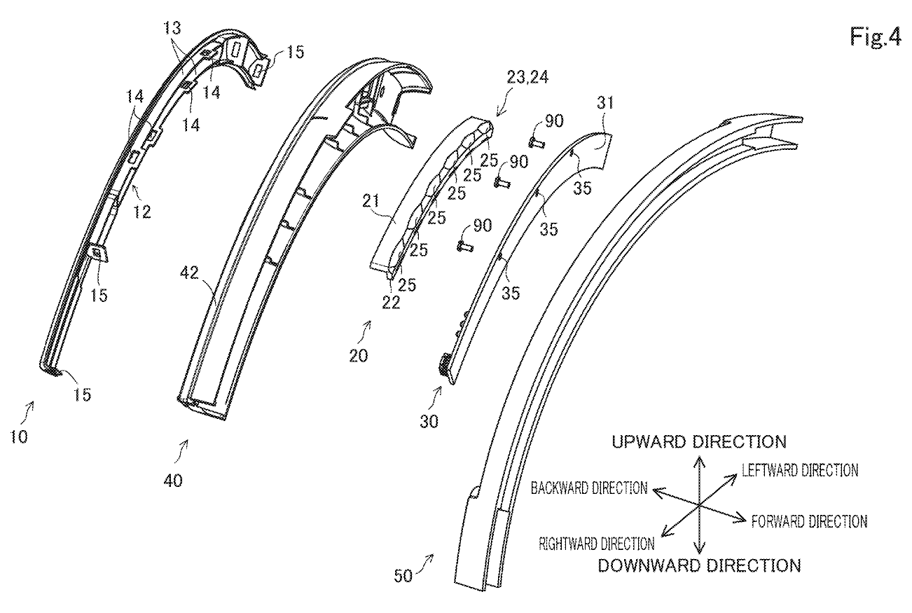

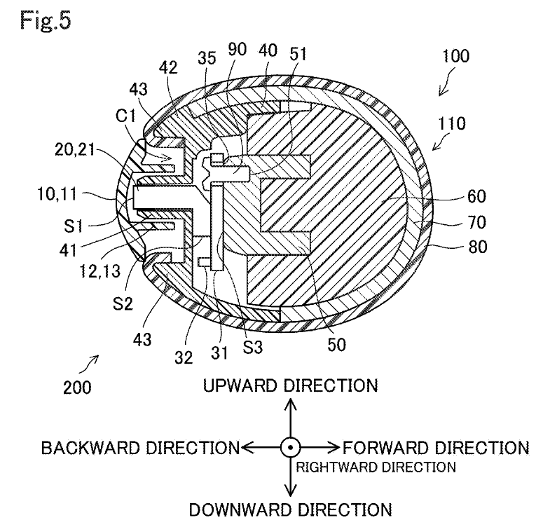

FIG. 3 is a first exploded perspective view showing a detailed configuration of the illumination device 200. FIG. 4 is a second exploded perspective view showing the detailed configuration of the illumination device 200. FIG. 5 is a sectional view showing a section of the steering wheel 100. FIG. 3 corresponds to an exploded perspective view when the illumination device 200 is viewed from the nearly backward direction side toward the nearly forward direction side. FIG. 4 corresponds to an exploded perspective view when the illumination device 200 is viewed from the nearly forward direction side toward the nearly backward direction side. FIGS. 3 and 4 each show a core metal 50 described later in addition to the illumination device 200. FIG. 5 shows a section along V-V indicated in FIG. 2.

As shown in FIGS. 3 and 4, the illumination device 200 includes the lens member 10 and the base member 40 in addition to the light-emitting part 30 and the light guide member 20 described above. The illumination device 200 has a configuration where the light guide member 20 and the light-emitting part 30, and the lens member 10 are assembled in the forward-backward direction across the base member 40 to be integrated.

As shown in FIGS. 3 and 4, the lens member 10 includes a diffusion surface forming portion 11, a second surrounding portion 12, and a plurality of engagement walls 15. As shown in FIG. 5, the diffusion surface forming portion 11 extends continuously with the outer coat layer 80 to form an outer surface of the steering wheel 100. As shown in FIGS. 3 and 4, like the substrate 31 described above, the diffusion surface forming portion 11 has an arc-like and stripe-shaped appearance shape curved in the peripheral direction of the gripping part 110 as viewed from a driver. The diffusion surface forming portion 11 has transmittance to visible light and infrared light, and forms a diffusion surface for diffusing light received from the light-emitting part 30 via the light guide member 20 into a vehicle interior. In the present embodiment, the diffusion surface forming portion 11 has a transmissivity of about 25% to visible light and has a transmissivity of about 90% to infrared light. The transmissivity to each of visible light and infrared light may be any value greater than 0%. In the present embodiment, the diffusion surface forming portion 11 is made of black and transparent synthetic resin to match the outer coat layer 80 in black. The diffusion surface forming portion 11 may be configured to be covered with the outer coat layer 80. Even in this configuration, providing the outer coat layer 80 with light transmittance still makes it possible to diffuse light received from the light-emitting part 30 into a vehicle interior using the diffusion surface.

In addition to the functions of diffusing light received from the light-emitting part 30 and protecting the light-emitting part 30, the diffusion surface forming portion 11 has the function of limiting a region where visible light emitted from the first LED 32 is to pass through (in other words, the function of masking a region desired not to shine), and the function of deflecting infrared light emitted from the second LED 33 so as to cause the emitted infrared light to travel upward toward the backward direction side corresponding to a driver side. A light-emitting region 19 shown in FIG. 1 is a region where visible light is to pass through. On the other hand, a region of the diffusion surface forming portion 11 other than the light-emitting region 19 is a region where transmission of visible light is limited.

As shown in FIG. 4, the second surrounding portion 12 is provided on a surface of the diffusion surface forming portion 11 on the forward direction side (inner surface). When the illumination device 200 is assembled to the second surrounding portion 12 (hereinafter also called an “assembled state” simply), the second surrounding portion 12 is arranged in such a manner as to surround a first surrounding portion 41 projecting toward the backward direction side from the recess part C1 of the base member 40 shown in FIGS. 3 and 5 along its entire periphery, and to surround a first light guide 21 described later corresponding to a part of the light guide member 20 housed in the first surrounding portion 41 along its entire periphery. The recess part C1 has a groove-like shape having an opening formed at a surface of the base member 40 on the forward direction side and extending in the peripheral direction. The second surrounding portion 12 has a projection 13 corresponding to a side wall extending in the radial direction and projecting in a depth direction of the recess part C1 from the surface of the diffusion surface forming portion 11 on the forward direction side, in other words, from the inner surface thereof. As clearly seen from FIGS. 3 and 5, the “depth direction of the recess part C1” of the present embodiment substantially conforms to the forward-backward direction. As shown in FIG. 4, the projection 13 is provided with a plurality of engagement holes 14. In the assembled state, engagement pawls 44 formed at an outer peripheral surface of the first surrounding portion 41 of the base member 40 (see FIG. 3) are engaged with the engagement holes 14. Such engagement is realized as so-called snap-fit. As shown in FIG. 4, each of the engagement walls 15 has a thin wall-like appearance shape projecting in the forward direction and is provided with an engagement hole. In the assembled state, the engagement wall 15 is arranged in contact with an engagement wall 45 of the base member 40 (see FIG. 3). In the assembled state, an engagement pawl formed at the engagement wall 45 is engaged with the engagement hole of the engagement wall 15. Such engagement is also realized as so-called snap-fit.

The light guide member 20 guides light emitted from the first LED 32 (visible light) to the lens member 10. In the present embodiment, the light guide member 20 is made of polycarbonate (PC) resin. The guide light member 20 may be made of acrylic resin instead of PC resin. As shown in FIGS. 3-5, the light guide member 20 has an appearance shape with a substantially L-shaped sectional shape along the axis AX. The light guide member 20 has an arc-like appearance shape viewed from a driver conforming to the locations of the plurality of first LEDs 32.

As shown in FIGS. 3-5, the light guide member 20 includes the first light guide 21, a second light guide 22, and a deflector 23. The first light guide 21 has an emission surface S1 for emission of visible light from the light guide member 20 toward the lens member 10. The first light guide 21 is extended in a direction (hereinafter also called a first direction) from the surface of the substrate 31 (surface on the backward direction side) toward the lens member 10. The first direction is parallel to the forward direction. The second light guide 22 has an incidence surface S2 for incidence of visible light output from the first LED 32. As shown in FIG. 5, the incidence surface S2 is located above the first LED 32. Thus, visible light from the first LED 32 travels upward to be incident on the incidence surface S2. The second light guide 22 is extended in a direction (hereinafter also called a second direction) intersecting the first direction. In the state shown in FIG. 5, the second direction corresponds to the upward direction and a substantially upward direction. In the present embodiment, the first direction and the second direction are perpendicular to each other. The deflector 23 forms connection between the first light guide 21 and the second light guide 22, and reflects visible light guided by the second light guide 22 and causes the reflected light to enter the first light guide 21. More specifically, the deflector 23 deflects visible light incident on the second light guide 22 from the incidence surface S2 and the travelling upward so that it travels forward, and causes the deflected visible light to enter the first light guide 21. As shown in FIG. 4, the deflector 23 has a deflection surface 24 for deflection of visible light. The deflection surface 24 is provided with a plurality of diffusion portions 25. Each diffusion portion 25 is arranged at a position corresponding to the upward direction with respect to each of the first LED 32. Each diffusion portion 25 has a depressed structure formed by chamfering the deflection surface 24 partially. More specifically, each diffusion portion 25 has a depressed structure such that the position corresponding to the upward direction with respect to each of the first LEDs 32 is the most deeply depressed, and gradually becomes shallower with a shorter distance to a position corresponding to the adjacent first LED 32 in the peripheral direction. The width of each diffusion portion 25, specifically, the dimension thereof in the upward-downward direction is largest at a position corresponding to the upward direction with respect to the first LED 32 (more correctly, in a direction toward an external side in the radial direction) and gradually becomes smaller with a shorter distance to the position corresponding to the adjacent first LED 32 in the peripheral direction. With the deflector 23 having the described configuration, visible light output from each of the first LEDs 32, which is so-called visible light from a point source of light, is diffused in the peripheral direction and the upward-downward direction when deflected by the deflector 23. As shown in FIG. 5, in the assembled state, the first light guide 21 is housed in the recess part C1. On the other hand, in the assembled state, the second light guide 22 and the deflector 23 are on the forward direction side with respect to the base member 40 and are not housed in the recess part C1.

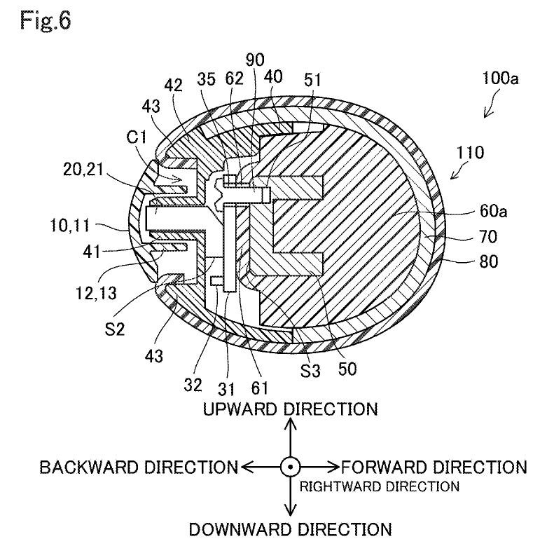

The base member 40 retains the second light guide 22 of the light guide member 20 and the light-emitting part 30 mounted on the forward direction side with respect to the base member 40 itself, and retains the first light guide 21 of the light guide member 20 and the lens member 10 mounted on the backward direction side with respect to the base member 40 itself. As shown in FIGS. 3 and 4, as viewed from a driver, the base member 40 has an arc-like and stripe-shaped appearance shape curved in the peripheral direction. In the present embodiment, the base member 40 is configured as a single component made of ABS resin. The base member 40 may be configured as a single component made of PC resin instead of ABS resin or in addition to ABS resin. Alternatively, the base member 40 may be configured as a composite part made up of a plurality of parts. As described above, the recess part C1 extending continuously in the peripheral direction is formed at the surface of the base member 40 on the backward direction side. As shown in FIGS. 3 and 5, the base member 40 includes a covering portion 42 provided at the surface thereof on the backward direction side and extending continuously in the peripheral direction on each of the upward direction side and the downward direction side across the recess part C1. As shown in FIGS. 5 and 6, an outer surface of the covering portion 42 has a sectional shape where a surface existing in the upward direction and a surface existing in the downward direction across an apex 43 form an acute angle. The covering portion 42 is covered with the outer coat layer 80 described later.

In the recess part C1, a through hole penetrating in the thickness direction is formed in a portion corresponding to the light guide member 20. As shown in FIG. 5, the first light guide 21 of the light guide member 20 is inserted in this through hole. As shown in FIGS. 3 and 5, the recess part C1 is provided with the above-described first surrounding portion 41 arranged in such a manner as to surround the through hole while the first light guide 21 is inserted therein. Like the second surrounding portion 12 of the lens member 10 shown in FIG. 4, the first surrounding portion 41 projects in the backward direction in such a manner as to come into contact with and surround the through hole along its entire periphery and a side surface of the first light guide 21 along its entire periphery inserted in the through hole. As shown in FIG. 3, the first surrounding portion 41 has a flat circular-cylindrical appearance shape curved in an arc-like form. As described above, the outer peripheral surface of the first surrounding portion 41 is provided with the plurality of engagement pawls 44. These engagement pawls 44 are engaged with the engagement holes 14 of the lens member 10 in the assembled state. The first surrounding portion 41 suppresses misalignment of the light guide member 20 including the first light guide 21 in the upward-downward direction and the rightward-leftward direction.

### A3. Detailed Configuration of Gripping Part 110

The other part of the gripping part 110 than a part mounted with the illumination device 200 has a sectional configuration differing from the sectional configuration of the part mounted with the illumination device 200 shown in FIG. 5 in that it is not mounted with the illumination device 200, but the other configurations are the same.

As shown in FIG. 5, the gripping part 110 includes the core metal 50, a core part 60, an element layer 70, the illumination device 200 described above, and the outer coat layer 80.

The core metal 50 is a member made of metal and functioning as a framework of the gripping part 110. In the present embodiment, the core metal 50 is made of an aluminum alloy. Instead of an aluminum alloy, any type of metal such as a magnesium alloy or steel may be used for forming the core metal 50. The core part 60 is arranged in such a manner as to cover a part of the core metal 50 on the forward direction side and forms a core of the gripping part 110. A part of the core metal 50 on the backward direction side is exposed without being covered with the core part 60. The core part 60 is a member used as a base material of the steering wheel 100, and is made of a soft synthetic resin having cushioning properties. More specifically, in the present embodiment, the core part 60 is made of a soft foam material such as polyurethane foam. The core part 60 corresponds to an impact absorbing member. The element layer 70 covers the core part 60 partially. The element layer 70 is a layer provided with a heating wire forming a heater unit or an electrode for detecting gripping. The element layer 70 is made of conductive cloth prepared by performing surface treatment such as carbon coating or metallic plating on fiber cloth, for example. As shown in FIG. 5, in the part of the gripping part 110 mounted with the illumination device 200, the element layer 70 further covers a part of the base member 40. An outer surface of the element layer 70 and an outer surface of the part of the base member 40 form a continuous curved surface. The outer coat layer 80 covers the outer surface of the element layer 70, the outer surface of the covering portion 42 of the base member 40, and an inner side of the recess part C1 of the base member 40 continuously. As shown in FIG. 5, a terminal portion of the leather member forming the outer coat layer 80 is housed in the recess part C1. The outer coat layer 80 is made of the leather member. In the present embodiment, the leather member is made of natural leather such as top-grain leather or split leather split from top-grain leather. Instead of the natural leather, any type of leather material such as composite leather or artificial leather may be used for forming the leather member.

### A4. Method of Manufacturing Steering Wheel 100

The following describes a method of manufacturing (a method of assembling) the steering wheel 100 having the above-described configuration. First, the lens member 10, the light guide member 20, the light-emitting part 30, and the base member 40 as the respective constituent elements of the illumination device 200 are manufactured. Next, the core metal 50 is manufactured. The core part 60 and the element layer 70 are formed in such a manner as to surround a part of the core metal 50 on the forward direction side. In the following, a member obtained in this way will be called a “wheel base material.” The wheel base material may be formed by two-color molding, for example. Then, the substrate 31 is placed on a backward end surface S3 of the core metal 50. In doing this, a surface of the substrate 31 (surface on the forward direction side) opposite to the surface thereof (surface on the backward direction side) provided with the first LED 32 is arranged in contact with the backward end surface S3 of the core metal 50. The substrate 31 is fixed with screws 90 to the core metal 50. More specifically, the screws 90 are passed through the through holes 35 provided at the substrate 31 to be threadedly engaged with screw holes 51 provided at the core metal 50. By doing so, the substrate 31 is fixed to the core metal 50 while being pressed with the screws 90 in the forward direction. The light guide member 20 and the base member 40 are thereafter located at predetermined positions, and the light guide member 20 and the base member 40 are fixed to the core metal 50 with screws 90 not shown in the drawings. In this way, an integrated assembly of the wheel base material, the light-emitting part 30, the light guide member 20, and the base member 40 is obtained. A leather member is thereafter wound on an outer surface of the assembly to form the outer coat layer 80. The outer coat layer 80 may be formed by winding several parts of the leather member in the peripheral direction, for example. Next, an adhesive agent is applied to a wall surface of the recess part C1 and the terminal portion of the outer coat layer 80 is bent in conformity with the shape of the covering portion 42 and housed in the recess part C1, thereby attaching the resultant terminal portion adhesively to the wall surface of the recess part C1. Next, the lens member 10 is fitted into the recess part C1, and the lens member 10 is attached to the base member 40 by snap-fit. In addition to the procedure described above, procedures are further taken such housing an airbag or an inflator not shown in the drawings into the boss part 130. Descriptions of these procedures will be omitted.

### A5. Fixing of Substrate 31 to Core metal 50

As described above, the screws 90 are passed through the through holes 35 at the substrate 31 to be threadedly engaged with the screw holes 51 provided at the core metal 50. By doing so, the substrate 31 is fixed to the core metal 50 while being pressed with the screws 90 in the forward direction. In this way, the surface of the substrate 31 on the forward direction side is arranged in contact with the backward end surface S3 of the core metal 50. Thus, heat of the substrate 31 generated by driving of the first LED 32 is transferred directly to the core metal 50. This achieves improvement of the performance of heat dissipation from the substrate 31 and eliminates the need for a member dedicated to the heat dissipation (heat transfer), making it possible to suppress increase in the cost of manufacturing the steering wheel 100 and increase in the size of the steering wheel 100. Furthermore, the substrate 31 and the core metal 50 are in surface-contact with each other. This allows heat dissipation from the substrate 31 to be facilitated compared to a configuration where the substrate 31 and the core metal 50 are in point-contact or line-contact with each other. Moreover, the substrate 31 is fixed with the screws 90. This allows the substrate 31 and the core metal 50 to come into contact with each other firmly, thereby achieving improvement of the heat dissipation performance. Furthermore, the substrate 31 is fixed to the core metal 50 highly resistive to impact. This makes it possible to reduce the occurrence of misalignment of the substrate 31 even if impact is applied from outside.

According to the above-described steering wheel 100 of the first embodiment, the substrate 31 is arranged in contact with the core metal 50. Thus, heat from the substrate 31 is dissipated by being transferred to the core metal 50, thereby eliminating the need for a dedicated member. This achieves heat dissipation from the substrate 31 while suppressing increase in the cost of manufacturing the steering wheel 100 and increase in the size of the steering wheel 100. Furthermore, the substrate 31 is in contact with the core metal 50 on the surface of the substrate 31 opposite to the surface thereof provided with the first LED 32, and is fixed with the screws 90 to the core metal 50. This allows heat dissipation from the substrate 31 to be facilitated compared to a configuration where the contact of the substrate 31 with the core metal 50 is not established between respective surfaces. This further allows improvement of heat transfer performance compared to a configuration where the substrate 31 is not fixed to the core metal 50 with the screws 90. Furthermore, the substrate 31 is fixed with the screws 90 to the core metal 50 highly resistive to impact. This makes it possible to reduce the occurrence of misalignment of the substrate 31 even if impact is applied from outside.

### B. Second Embodiment

FIG. 6 is a sectional view showing a section of a steering wheel 100a according to a second embodiment. The steering wheel 100a of the second embodiment differs from the steering wheel 100 of the first embodiment in that it includes a core part 60a instead of the core part 60. The other configuration of the steering wheel 100a of the second embodiment is the same as that of the steering wheel 100 of the first embodiment. Thus, a corresponding constituent element will be given the same sign and detailed description thereof will be omitted.

The core part 60a differs from the core part 60 of the first embodiment in that it includes an intermediary part 61. The intermediary part 61 has a sheet-like appearance configuration and covers a part of the core metal 50 on the backward direction side. The intermediary part 61 forms a part of the core part 60a, and like the other part of the core part 60a, is made of a soft foam material such as polyurethane foam functioning as an impact absorbing member. In the present embodiment, the thickness of the intermediary part 61, specifically, the dimension thereof in the forward-backward direction in FIG. 6 is equal to or less than 2 mm (millimeters) in an assembled state shown in FIG. 6. The intermediary part 61 is provided with a through hole 62 formed in advance for allowing the screw 90 to pass therethrough.

As shown in FIG. 6, in the second embodiment, the substrate 31 is arranged in contact with the intermediary part 61. More specifically, the contact of the substrate 31 is formed between the surface of the substrate 31 (surface on the forward direction side) opposite to the surface thereof provided with the first LED 32 and a backward end surface of the intermediary part 61. The substrate 31 is fixed with the screw 90 to the core metal 50 via the intermediary part 61. More specifically, the screw 90 is passed through the through hole 35 at the substrate 31 and the through hole 62 at the intermediary part 61 to be threadedly engaged with screw hole 51 provided at the core metal 50. By doing so, the substrate 31 is fixed to the core metal 50 via the intermediary part 61 while being pressed with the screw 90 in the forward direction.

Here, the intermediary part 61 is made of a soft foam material such as polyurethane foam that may be said to be a heat-insulating material. In this regard, the intermediary part 61 has a sheet-like appearance configuration and has a thickness equal to or less than 2 mm as described above. Thus, heat from the substrate 31 is transferred to the core metal 50 via the intermediary part 61. Furthermore, the substrate 31 is fixed with the screw 90 to the core metal 50 and the screw 90 is threadedly engaged with the screw hole 51 at the core metal 50. This allows the heat from the substrate 31 to be transferred also via the screw 90.

The above-described steering wheel 100a of the second embodiment achieves effects comparable to those of the steering wheel 100 of the first embodiment. Specifically, the substrate 31 is in indirect contact with the core metal 50 via the sheet-like intermediary part 61, and the intermediary part 61 is configured as a part of the core part 60a that is a member used as a base material of the steering wheel 100a. Thus, heat from the substrate 31 is dissipated by being transferred to the core metal 50, thereby eliminating the need for a dedicated member. This achieves heat dissipation from the substrate 31 while suppressing increase in the cost of manufacturing the steering wheel 100a and increase in the size of the steering wheel 100a. Furthermore, the substrate 31 is in contact with the intermediary part 61 on the surface of the substrate 31 opposite to the surface thereof provided with the first LED 32, and is fixed with the screws 90 to the core metal 50 via the intermediary part 61. This allows heat dissipation from the substrate 31 to be facilitated compared to a configuration where the contact of the substrate 31 with the intermediary part 61 is not established between respective surfaces. This further allows improvement of heat transfer performance compared to a configuration where the substrate 31 is not fixed to the core metal 50 with the screw 90. Furthermore, the substrate 31 is fixed with the screw 90 to the core metal 50 highly resistive to impact. This makes it possible to reduce the occurrence of misalignment of the substrate 31 even if impact is applied from outside.

The intermediary part 61 is configured as a part of the impact absorbing member arranged in such a manner as to cover at least a part of the core metal 50. This makes it possible to improve impact resistances of the substrate 31 and the core metal 50 while achieving heat dissipation from the substrate 31.

The thickness of the intermediary part 61 is equal to or less than 2 mm. This allows improvement of heat transfer performance compared to a configuration where the intermediary part 61 has a greater thickness.

### C. Other Embodiments

(C1) In each of the embodiments, the substrate 31 is fixed to the core metal 50 through screw fastening. However, the present disclosure is not limited to this. In an exemplary configuration, one of the substrate 31 and the core metal 50 may be provided with an engagement pawl, the other may be provided with an engagement hole to be engaged with the engagement pawl, and the substrate 31 may be fixed to the core metal 50 by forming engagement between the engagement hole and the engagement pawl. This configuration including the engagement pawl and the engagement hole may be applied to the second embodiment by providing the intermediary part 61 with a through hole for causing the engagement pawl to pass therethrough.

(C2) In the second embodiment, the intermediary part 61 is configured as a part of the core part 60a, in other words, a part of the impact absorbing member. However, the present disclosure is not limited to this. As an example, a part of the base member 40 may be configured as an intermediary part and the substrate 31 may be fixed to the core metal 50 indirectly via the intermediary part.

(C3) In each of the embodiments, the illumination device 200 is provided at the gripping part 110. However, the present disclosure is not limited to this. In an exemplary configuration, the illumination device 200 may be provided at an arbitrary part of the steering wheel 100, 100a such as the boss part 130 or the spoke part 120. In this case, the shape and configuration of the illumination device 200 are suitably changeable in conformity with the size, shape, etc. of a place where the illumination device 200 is provided. The position of the illumination device 200 is desirably a position where the illumination device 200 is visually recognizable directly from a driver. However, if light emitted from the illumination device 200 is to be reflected on a surface of an arbitrary part inside a vehicle such as a surface of an instrument panel, for example, and if resultant reflected light is to be visually recognizable from a driver, for example, the position of the illumination device 200 may be a position where the illumination device 200 is visually unrecognizable directly from the driver.

(C4) The configuration of the steering wheel 100, 100a in each of the embodiments is given just as an example and is changeable in various ways. For example, in each of the embodiments, the substrate 31 may be in point-contact or line-contact with the core metal 50 or the intermediary part 61. In the second embodiment, the thickness of the intermediary part 61 may be greater than 2 mm as long as such a thickness allows heat from the substrate 31 to be transferred to the core metal 50. In each of the embodiments, the projection 13 is omissible. In each of the embodiments, the plurality of second LEDs 33 is omissible. In each of the embodiments, the light guide member 20 has the substantially L-shaped sectional shape along the axis AX. Namely, the first direction and the second direction are perpendicular to each other. However, in one configuration, the first light guide 21 and the second light guide 22 may be arranged in such a manner that the first direction and the second direction intersect with each other at an arbitrary angle other than 90°.

The present disclosure is not limited to each of the embodiments described above and is able to be realized with various configurations without departing from the spirit thereof. For example, technical features in the embodiments corresponding to the technical features in the aspects described in the section of SUMMARY are able to be replaced with each other or combined together, as appropriate, in order to solve part or the whole of the problems described previously or to achieve part or the whole of the effects described previously. When the technical features are not described as essential features in the present specification, they are able to be deleted, as appropriate. For example, the present disclosure may be realized in aspects described below.

(1) According to one aspect of the present disclosure, a steering wheel is provided. The steering wheel comprises: a substrate having a surface provided with a light-emitting element; and a core metal forming a skeleton of the steering wheel. The substrate is arranged in contact with the core metal.

According to the steering wheel of this aspect, the substrate is arranged in contact with the core metal. Thus, heat from the substrate is dissipated by being transferred to the core metal, thereby eliminating the need for a dedicated member. This achieves heat dissipation from the substrate while suppressing increase in the cost of manufacturing the steering wheel and increase in the size of the steering wheel.

(2) In the steering wheel of the above aspect, the substrate may be in contact with the core metal on a surface of the substrate opposite to the surface thereof provided with the light-emitting element, and may be fixed with a screw to the core metal.

According to the steering wheel of this aspect, the substrate is in contact with the core metal on the surface of the substrate opposite to the surface thereof provided with the light-emitting element, and is fixed with the screw to the core metal. This allows heat dissipation from the substrate to be facilitated compared to a configuration where the contact of the substrate with the core metal is not established between respective surfaces. This further allows improvement of heat transfer performance compared to a configuration where the substrate is not fixed to the core metal with a screw. Furthermore, the substrate is fixed with the screw to the core metal highly resistive to impact. This makes it possible to reduce the occurrence of misalignment of the substrate even if impact is applied from outside.

(3) According to another aspect of the present disclosure, a steering wheel is provided. The steering wheel comprises: a substrate having a surface provided with a light-emitting element; a core metal forming a skeleton of the steering wheel; and a sheet-like intermediary part interposed between the substrate and the core metal, the intermediary part being configured as a part of a member used as a base material of the steering wheel.

According to the steering wheel of this aspect, the substrate is in indirect contact with the core metal via the sheet-like intermediary part, and the intermediary part is configured as a part of the member used as the base material of the steering wheel. Thus, heat from the substrate is dissipated by being transferred to the core metal, thereby eliminating the need for a dedicated member. This achieves heat dissipation from the substrate while suppressing increase in the cost of manufacturing the steering wheel and increase in the size of the steering wheel.

(4) In the steering wheel of the above aspect, the intermediary part may be configured as a part of an impact absorbing member arranged in such a manner as to cover at least a part of the core metal.

According to the steering wheel of this aspect, the intermediary part is configured as a part of the impact absorbing member arranged in such a manner as to cover at least a part of the core metal. This makes it possible to improve impact resistances of the substrate and the core metal while achieving heat dissipation from the substrate.

(5) In the steering wheel of the above aspect, the intermediary part may have a thickness equal to or less than 2 mm (millimeters).

According to the steering wheel of this aspect, the thickness of the intermediary part is equal to or less than 2 mm. This allows improvement of heat transfer performance compared to a configuration where the intermediary part has a greater thickness.

(6) In the steering wheel of the above aspect, the substrate may be in contact with the intermediary part on a surface of the substrate opposite to the surface thereof provided with the light-emitting element, and may be fixed with a screw to the core metal via the intermediary part.

According to the steering wheel of this aspect, the substrate is in contact with the intermediary part on the surface of the substrate opposite to the surface thereof provided with the light-emitting element, and is fixed with the screw to the core metal via the intermediary part. This allows heat dissipation from the substrate to be facilitated compared to a configuration where the contact of the substrate with the core metal is not established between respective surfaces. This further allows improvement of heat transfer performance compared to a configuration where the substrate is not fixed to the core metal with a screw. Furthermore, the substrate is fixed with the screw to the core metal highly resistive to impact. This makes it possible to reduce the occurrence of misalignment of the substrate even if impact is applied from outside.

What is claimed is:

1. A steering wheel comprising:
a substrate having a surface provided with a light-emitting element; and
a core metal forming a skeleton of the steering wheel, wherein
the substrate is arranged in contact with the core metal.

2. The steering wheel according to claim 1, wherein
the substrate is in contact with the core metal on a surface of the substrate opposite to the surface thereof provided with the light-emitting element, and is fixed with a screw to the core metal.

3. A steering wheel comprising:
a substrate having a surface provided with a light-emitting element;
a core metal forming a skeleton of the steering wheel; and
a sheet-like intermediary part interposed between the substrate and the core metal, the intermediary part being configured as a part of a member used as a base material of the steering wheel.

4. The steering wheel according to claim 3, wherein
the intermediary part is configured as a part of an impact absorbing member arranged in such a manner as to cover at least a part of the core metal.

5. The steering wheel according to claim 4, wherein
the intermediary part has a thickness equal to or less than 2 mm (millimeters).

6. The steering wheel according to claim 3, wherein
the substrate is in contact with the intermediary part on a surface of the substrate opposite to the surface thereof provided with the light-emitting element, and is fixed with a screw to the core metal via the intermediary part.
